(19) United States
(12) Patent Application Publication
(10) Pub. No.: US 2015/0262589 A1
(43) Pub. Date: Sep. 17, 2015

(54) SOUND PROCESSOR, SOUND PROCESSING METHOD, PROGRAM, ELECTRONIC DEVICE, SERVER, CLIENT DEVICE, AND SOUND PROCESSING SYSTEM

(71) Applicant: Sony Corporation, Tokyo (JP)

(72) Inventors: Akira Inoue, Tokyo (JP); Shusuke Takahashi, Chiba (JP); Shuichiro Nishigori, Tokyo (JP)

(21) Appl. No.: 14/377,688

(22) PCT Filed: Jan. 17, 2013
(86) PCT No.: PCT/JP2013/050722

§ 371 Date: Aug. 8, 2014

(30) Foreign Application Priority Data
Feb. 16, 2012 (JP) 2012-032139

(51) Int. Cl. G10L 21/013

(52) U.S. Cl. CPC G10L 21/013

(57) ABSTRACT

It is possible to mark karaoke using commercial musical content.

A first pitch feature amount is calculated for each predetermined time interval from a music acoustic signal. A second pitch feature amount is calculated from a target comparison acoustic signal, such as a singing voice signal, for every time interval corresponding to the specified time interval. A similarity between acoustic signals is calculated by comparison of the first pitch feature amount and the second pitch feature amount. The pitch feature of the musical composition audio calculated from the music acoustic signal is set as model data. For example, it is possible to mark karaoke using commercial music content provided on a CD or the like.

### TECHNICAL FIELD

The present technology relates to an acoustic processing apparatus, an acoustic processing method, a program, an electronic apparatus, a server apparatus, a client apparatus, and an acoustic processing system, and, in particular, to an acoustic processing apparatus or the like able to mark karaoke using commercial music content.

### BACKGROUND ART

Most karaoke marking methods, systems and apparatuses of the related art prepare singing main melody data that is a model in addition to accompaniment data that does not include the singing main melody of music, and perform marking according to the degree of matching between pitch time series data extracted from the singing voice of the singer that is the marking target and the singing main melody data (for example, PTL 1). Such a karaoke marking function is provided through karaoke apparatuses or karaoke games installed in karaoke shops and restaurants in town, and Internet services or the like.

Meanwhile, current commercial music content is delivered to end users in forms such as a physical media package, such as a CD, or by download sales in a compressed audio file format, such as MP3 and AAC, through a communication line, such as the Internet. Most commercial music content is ordinarily provided as an audio signal in which the singing and accompaniment are indistinctly recorded, and in this case, the singing main melody is not provided as independent data.

If a technology exists that extracts only the singing main melody signal from an audio signal of commercial music content in which the singing and accompaniment are mixed, it is possible to realized karaoke marking with the method of the related art. However, even though there has been much research, it is difficult to say that there is sufficient precision in the signal extraction of the singing main melody. In consideration of the above situation, it can be said that there has until now been no means for enjoying karaoke marking only with commercial music content provided as a CD or a compressed audio file format.

For control of acoustic effects of karaoke of the related art, it is common for a singer to use a karaoke apparatus (karaoke machine in a karaoke box, PC or game software), and to perform preselected adjustment of the echo and harmony, that is, to turn on or off and to control the strength and weakness of the functions. A method in which the music provider side prepares these acoustic effects in advance to match the atmosphere of the music in such a way that the acoustic effects are automatically applied has also been proposed (for example, refer to PTL 2).

However, in the case of the user setting the acoustic effect in advance, the effect is continued to be the same at the start and finish, and auditory stimulation is lacking. When used by a person with little singing ability, dissonance is generated with respect to the harmony, and not only the singer themself, but the surrounding listeners are also made uncomfortable. In a case in which the acoustic effects are changed to match the atmosphere of the music, although a given extent of auditory stimulation is obtained, the problems remain of the time and effort in the music provider side setting the acoustic effect in advance or the dissonance in a case in which a singer with little singing ability uses harmony.

### CITATION LIST

### Patent Literature

PTL 1: Japanese Unexamined Patent Application Publication No. 4-070690

PTL 2: Japanese Unexamined Patent Application Publication No. 11-052970

### SUMMARY OF INVENTION

### Technical Problem

An object of the present technology is to enable karaoke marking using commercial music content. Another object of the present technology is to enable application of acoustic effects in real time according to the singing ability of the singer.

### Solution to Problem

According to an aspect of the present technology, there is provided an acoustic processing apparatus including a first feature amount calculator that calculates a first pitch feature amount from a music acoustic signal for each predetermined time interval; a second feature amount calculator that calculates a second pitch feature amount from a target comparison acoustic signal for each time interval corresponding to the predetermined time interval; and a similarity calculator that calculates a similarity between acoustic signals by comparison of the first pitch feature amount and the second pitch feature amount.

In the technology, the first pitch feature amount is calculated from the music acoustic signal for each predetermined time interval by the first feature amount calculator. The music acoustic signal, for example, is provided by a media package, such as a CD, or is provided by a communication line, such as the Internet. The predetermined time interval, for example, is a comparatively short time interval within the time such that a feature amount is approximately constant.

The second pitch feature amount is calculated by the second feature amount calculator from the target comparison acoustic signal for each time interval corresponding to the predetermined time interval. The comparison acoustic signal is a singing voice signal or a musical instrument performance signal. The time interval corresponding to the predetermined time interval does not necessarily correspond one-to-one to the predetermined time interval, and may have a correspondence relationship with the predetermined time interval. For example, the time interval corresponding to the predetermined time interval may be a time interval of an integer multiple of the predetermined time interval.

For example, in the first feature amount calculator, signal intensity information for each time period or each frequency of the music acoustic signal is calculated as the first pitch feature amount. For example, in the second feature amount calculator, the time period or frequency of each signal component included in the target comparison acoustic signal is calculated as the second pitch feature amount.

A similarity between acoustic signals is calculated by the similarity calculator by comparison of the first pitch feature amount and the second pitch feature amount. For example, the above-described signal intensity information as the first pitch feature amount may be used as is, or may be binarized and used. It is possible to reduce the calculation amount for the similarity calculation by being binarized and used. For example, a time period that is double the time period or a frequency that is ½ the frequency may be used, in addition to the time period or the frequency as the second pitch feature amount.

In the present technology, the similarity between acoustic signals is calculated by comparison between a first pitch feature amount calculated from a music acoustic signal for each predetermined time interval and a second pitch feature amount calculated from the target comparison acoustic signal for each time interval corresponding to the predetermined time interval, and, for example, it is possible to mark karaoke using commercial music content.

In the present technology, an acoustic effect application portion that applies a predetermined acoustic effect to the singing voice signal according to the similarity may be further included. In this case, it is possible to apply acoustic effects in real time according to the singing ability of the singer.

According to another aspect of the present invention, there is provided an electronic apparatus including an accompaniment audio output portion that performs output of accompaniment audio according to a music acoustic signal; an acoustic signal acquisition portion that acquires a target comparison acoustic signal; and a signal processing portion that performs comparison processing between the target comparison acoustic signal and the music acoustic signal, in which the signal processing portion includes a first feature amount calculator that calculates a first pitch feature amount from the music acoustic signal for each predetermined time interval, a second feature amount calculator that calculates a second pitch feature amount from the target comparison acoustic signal for each time interval corresponding to the predetermined time interval, and a similarity calculator that calculates a similarity between acoustic signals by comparison of the first pitch feature amount and the second pitch feature amount.

According to still another aspect of the present technology, there is provided an acoustic processing apparatus including a marking processing portion that performs a marking processes based on a singing voice signal; and an acoustic effect application portion that applies a predetermined acoustic effect to the singing voice signal according to a result of the marking process.

In the technology, the marking process is performed based on the singing voice signal by the marking processing portion. A predetermined acoustic effect is applied to the singing voice signal according to the result of the marking process by the acoustic effect application portion. For example, the marking processing portion may be set so as to perform the marking process by calculating a similarity between a music acoustic signal and the singing voice signal. For example, the marking processing portion may include a first feature amount calculator that calculates a first pitch feature amount from the music acoustic signal for each predetermined time interval, a second feature amount calculator that calculates a second pitch feature amount from the singing voice signal for each time interval corresponding to the predetermined time interval, and a similarity calculator that calculates a similarity between acoustic signals by comparison of the first pitch feature amount and the second pitch feature amount.

In the technology, predetermined acoustic effects are applied to the singing voice signal according to the results of the marking process based on the singing voice signal, and it is possible to apply acoustic effects in real time according to the singing ability of the singer.

According to still another aspect of the invention, there is provided an acoustic processing system including a server apparatus and a client apparatus, in which the server apparatus includes a feature amount calculator that calculates a first pitch feature amount from a music acoustic signal for each predetermined time interval, and an information transmitter that transmits information based on the first pitch feature amount to a client apparatus, and the client apparatus includes an acoustic signal acquisition portion that acquires a target comparison acoustic signal, and a similarity acquisition portion that acquires a similarity between acoustic signals calculated by comparison between the first pitch feature amount and a second pitch feature amount calculated from the target comparison acoustic signal for each time interval corresponding to the predetermined time interval.

The present technology is formed by a server apparatus and a client apparatus. A feature amount calculator and an information transmitter are provided in the server apparatus. The first pitch feature amount is calculated from the music acoustic signal for each predetermined time segment by the feature amount calculator. Information based on the first pitch feature amount is transmitted to the client apparatus by the information transmitter.

For example, the server apparatus may further include an acoustic signal receiver that receives a target comparison acoustic signal from the client apparatus; a second feature amount calculator that calculates a second pitch feature amount from the target comparison acoustic signal for each time interval corresponding to the predetermined time interval; and a similarity calculator that calculates a similarity between acoustic signals by comparison of the first pitch feature amount and the second pitch feature amount, in which the information transmitter transmits the similarity to the client apparatus.

For example, the server apparatus may further include a feature amount receiver that receives a second pitch feature amount calculated from a target comparison acoustic signal for each time interval corresponding to the predetermined time interval from the client apparatus; and a similarity calculator that calculates a similarity between acoustic signals by comparison of the first pitch feature amount and the second pitch feature amount, in which the information transmitter transmits the similarity to the client apparatus.

An acoustic signal acquisition portion and a similarity acquisition portion are included in the client apparatus. The target comparison acoustic signal is acquired by the acoustic signal acquisition portion. A similarity between acoustic signals calculated by comparison between the first pitch feature amount and a second pitch feature amount calculated from the target comparison acoustic signal for each time interval corresponding to the predetermined time interval is acquired by the similarity acquisition portion.

For example, the client apparatus may further include a feature amount calculator that calculates the second pitch feature amount from the target comparison acoustic signal; a feature amount receiver that receives the first pitch feature amount from a server apparatus; and a similarity calculator that calculates a similarity between acoustic signals by comparison of the first pitch feature amount and the second pitch feature amount, in which the similarity acquisition portion acquires the similarity from the similarity calculator.

For example, the client apparatus may further include a feature amount calculator that calculates the second pitch feature amount from the target comparison acoustic signal; a feature amount transmitter that transmits the first pitch feature amount to the server apparatus; and a similarity receiver that receives the similarity from the server apparatus, in which the similarity acquisition portion acquired the similarity from the similarity receiver.

In the present technology, a process of calculating the first pitch feature amount from the music acoustic signal is performed by at least the server apparatus, and it is possible to reduce the processing burden and the circuit scale of the user side apparatus.

### Advantageous Effects of Invention

According to the present invention, it is possible to mark karaoke using commercial music content. According to the present technology, it is possible to apply acoustic effects in real time according to the singing ability of the singer.

### BRIEF DESCRIPTION OF DRAWINGS

FIG. 1 is a block diagram showing a configuration example of a karaoke apparatus as an embodiment.

FIG. 2 is a block diagram showing a configuration example of a marking processing portion that configures the karaoke apparatus.

FIG. 3 is a diagram showing one example of signal intensity information for each time period of a music acoustic signal in a given time interval.

FIG. 4 is a diagram schematically representing an example of signal intensity information for each time period of a music acoustic signal calculated in each time interval.

FIG. 5 is a diagram showing a binarized example of signal intensity information for each time period of a music acoustic signal calculated in each time interval.

FIG. 6(a) is a diagram showing an example of binarized signal intensity information of each time period for each time interval of a music acoustic signal. FIG. 6(b) is a diagram showing an example of time period information for each time period of a singing voice signal.

FIG. 7 is a flowchart of one example of a marking process procedure in marking process example 1 of the marking processing portion.

FIG. 8(a) is a diagram showing an example of signal intensity information of each time period for each time interval of a music acoustic signal. FIG. 8(b) is a diagram showing an example of time period information for each time period of a singing voice signal.

FIG. 9 is a flowchart of one example of a marking process procedure in marking process example 2 of the marking processing portion.

FIG. 10 is a diagram showing an example of binarized signal intensity information of each time period for each time interval of a music acoustic signal. FIG. 10(b) is a diagram showing an example of time period information for each time period of a singing voice signal.

FIG. 11 is a flowchart of one example of a marking process procedure in marking process example 3 of the marking processing portion.

FIG. 12 is a block diagram showing an example of an additional processing configuration with respect to the marking processing portion.

FIG. 13 is a block diagram showing configuration example 1 of the marking processing portion configured by a client apparatus and a server apparatus.

FIG. 14 is a block diagram showing configuration example 2 of the marking processing portion configured by a client apparatus and a server apparatus.

FIG. 15 is a block diagram showing configuration example 3 of the marking processing portion configured by a client apparatus and a server apparatus.

FIG. 16 is a block diagram showing another configuration example of a marking processing portion that configures the karaoke apparatus.

FIG. 17 is a block diagram showing a configuration example of an acoustic effect application portion that configures the karaoke apparatus.

FIG. 18 is a block diagram showing another configuration example of an acoustic effect application portion that configures the karaoke apparatus.

### DESCRIPTION OF EMBODIMENTS

Below, description will be given of embodiments for realizing the invention (below, referred to as “embodiments”). The description will be given in the following order.

1. Embodiments

2. Modification Examples

### 1. Embodiments

### Configuration Example of Karaoke Apparatus

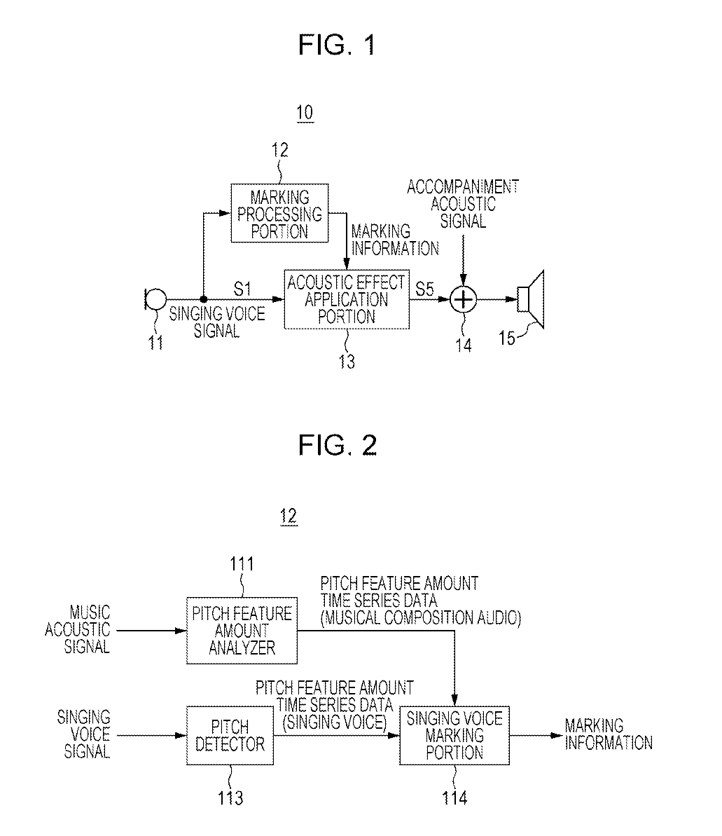

FIG. 1 shows a configuration example of a karaoke apparatus 10 as an embodiment. The karaoke apparatus 10 includes a microphone 11, a marking processing portion 12, an acoustic effect application portion 13, an adder 14 and a speaker 15.

The microphone 11 configures the acquisition portion for the singing voice signal. The user (singer) inputs a singing voice matching accompaniment audio from the microphone 11, and the microphone 11 outputs a singing voice signal corresponding to the singing voice. The marking processing portion 12 performed a marking process based on the singing voice signal and outputs marking information showing a similarity.

The acoustic effect application portion 13 applies a predetermined acoustic effect to the singing voice signal output from the microphone 11 according to the marking information as a marking process result. The adder 14 adds the singing voice signal output from the acoustic effect application portion 13 to the accompaniment audio signal. The speaker 15 outputs audio (accompaniment audio, singing audio) by the output signal of the adder 14.

### Configuration Example of Marking Processing Portion

FIG. 2 shows a configuration example of the marking processing portion 12. The marking processing portion 12 performs a marking process using commercial music content, that is, a music acoustic signal in which the singing and accompaniment are indistinctly recorded. The marking processing portion 12 includes a pitch feature amount analyzer 111, a pitch detector 113, and a singing voice marking portion 114.

The pitch feature amount analyzer 111 analyzes the music acoustic signal, and calculates the pitch feature amount of the musical composition audio for each predetermined time interval. Here, the predetermined time interval, for example, is a comparatively short time interval such that the feature amount in the time interval is approximately constant, such as 20 msec and 40 msec. Here, the calculated acoustic feature amount is considered the signal intensity information for each time period or for each frequency of the music acoustic signal. The pitch feature amount analyzer 111 obtains time series data of the pitch feature amount of the music acoustic signal by calculating the above-described pitch feature amount in the all of the above-described predetermined time interval of the music acoustic signal.

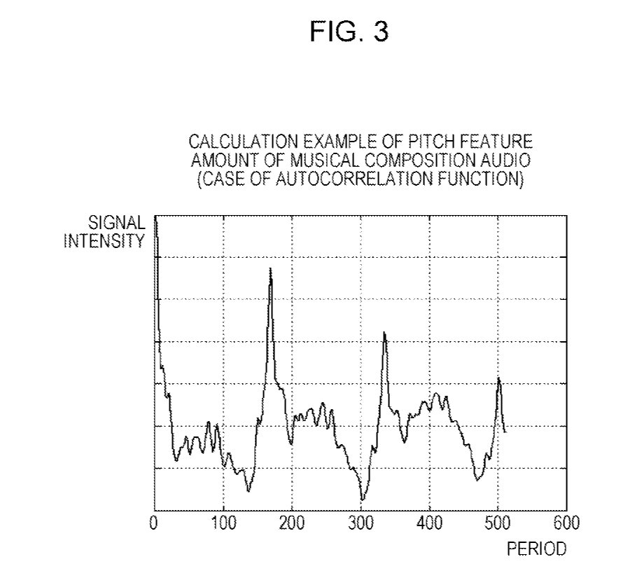

The signal intensity information for each time period of the music acoustic signal, for example, is calculated using an autocorrelation function formula represented in the following expression (1). FIG. 3 shows one example of signal intensity information for each time period of a music acoustic signal in a given time interval. The example shown in the drawings is a plot of values of R(T) when the time period T is changed from 0 to 512. The period of the horizontal axis represents the above-described T, and the signal intensity of the vertical axis represents the above-described (T).

$$\begin{matrix}[ Equation 1 ] & \\ R ( T ) = {\sum }_{t = 0}^{N - 1} s ( t ) \cdot s ( t + T ) & ( 1 )\end{matrix}$$

R(T): autocorrelation with time difference (period) T
s(t): input time signal during time t
N: data number

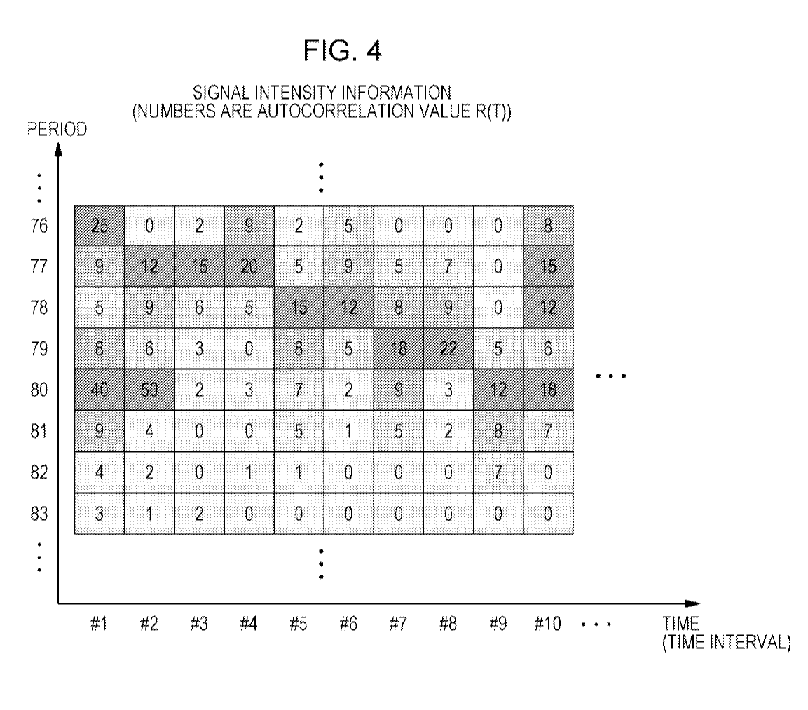

FIG. 4 is an example schematically representing signal intensity information for each time period of a music acoustic signal calculated in each time interval. The “#1, #2, #3 . . . ” of the horizontal axis represent the respective time intervals, and the “ . . . 76, 77, 78 . . . ” of the vertical axis represent the respective time periods. In the examples depicted in the drawing, the time period in which the auto correlation value R(T) is large is represented by a dark state.

The signal intensity information for each frequency of the music acoustic signal, for example, is calculated by performing a short-time Fourier transform. Below, obtaining the signal intensity information for each time period of the music acoustic signal with the pitch feature amount analyzer 111 will be described. However, although a detailed description will not be made, it is possible to obtain marking information by similar processing even in a case in which the signal intensity information is calculated for each frequency of the music acoustic signal in the pitch feature amount analyzer 111.

The pitch detector 113 calculates the pitch feature amount from the singing voice signal for each time segment corresponding to the above-described predetermined time interval. The time interval corresponding to the predetermined time interval may be the same as the predetermined time interval or may be different. That is, the time interval corresponding to the predetermined time interval does not necessarily correspond one-to-one to the predetermined time interval, and may have a correspondence relationship with the predetermined time interval. For example, the time interval corresponding to the predetermined time interval may be a time interval of an integer multiple of the predetermined time interval. Below, a one to one correspondence between the time interval and the predetermined time interval will be described. The pitch detector 113 obtains time series data of the pitch feature amount of the singing voice signal by calculating the above-described pitch feature amount in each time interval of the singing voice signal.

The calculated acoustic feature amount is considered time period information or period information of the singing voice signal. The time period information of the singing voice signal, for example, is calculated using the autocorrelation function formula represented by the above-described expression (1). In this case, the pitch detector 113 extracts a basic period showing a strong correlation value. The frequency information of the singing voice signal is calculated by performing a short-time Fourier transform. In this case, the pitch detector 113 extracts the lowest peak frequency in order that the power spectrum of the period signal hold a peak as an integer multiple of the basic frequency. After the frequency information of the singing voice signal is calculated, it is also possible to easily perform conversion of the frequency information to the above-described time period information. Below, obtaining the time period information of the singing voice signal with the pitch detector 113 will be described.

The singing voice marking portion 114 calculates the marking information indicating the similarity between acoustic signals by comparison of the pitch feature amount of the music acoustic signal obtained by the pitch feature amount analyzer 111 and the pitch feature amount of the singing voice signal obtained by the pitch detector 113. In the singing voice marking portion 114, the signal intensity information for each time period of the music acoustic signal obtained by the pitch feature amount analyzer 111 is used as is, or is binarized and used. It is possible to reduce the calculation amount through the binarizing. In the singing voice marking portion 114, the time period information of the singing voice signal obtained by the pitch detector 113 is used as is, or the time period information is further doubled and used. Here, the doubled time period is the ½ frequency, in terms of frequency.

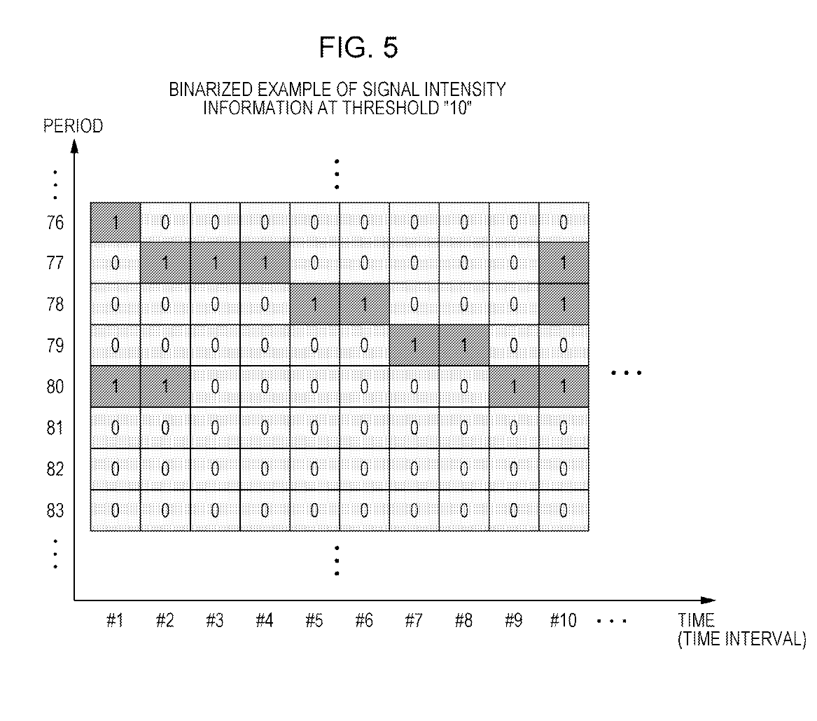

FIG. 5 is a binarized example of signal intensity information for each time period of a music acoustic signal calculated in each time interval. The example depicted is an example in which the signal intensity information for each time period of the music acoustic signal shown in the above-described FIG. 4 is binarized at the threshold 10. In the example depicted, the time period in which the signal intensity information is “1” is represented by a dark state.

A marking process example in the marking processing portion 12 will be described.

### Marking Process Example 1

In marking process example 1, the signal intensity information for each time period is calculated as a pitch feature amount of the music acoustic signal for each predetermined time interval by the pitch feature amount analyzer 111, and binarized information of the signal intensity information is used in the singing voice marking portion 114. In marking process example 1, time period information that is the pitch feature amount of the singing voice signal for each predetermined time interval is calculated by the pitch detector 113, and the time period information thereof is used in the singing voice marking portion 114.

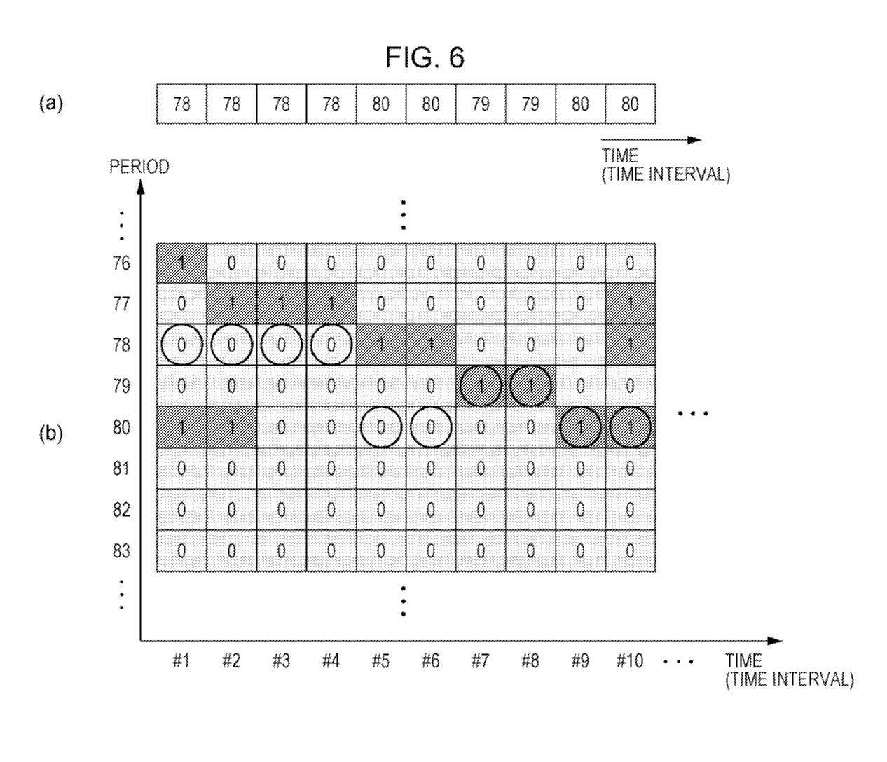

FIG. 6(b) shows an example of binarized signal intensity information of each time period for each time interval of a music acoustic signal. FIG. 6(a) shows an example of time period information for each time interval of a singing voice signal. In FIG. 6(b), in each time interval, locations of the time period which the time period information of the singing voice signal shows are indicated by applying a “O” mark.

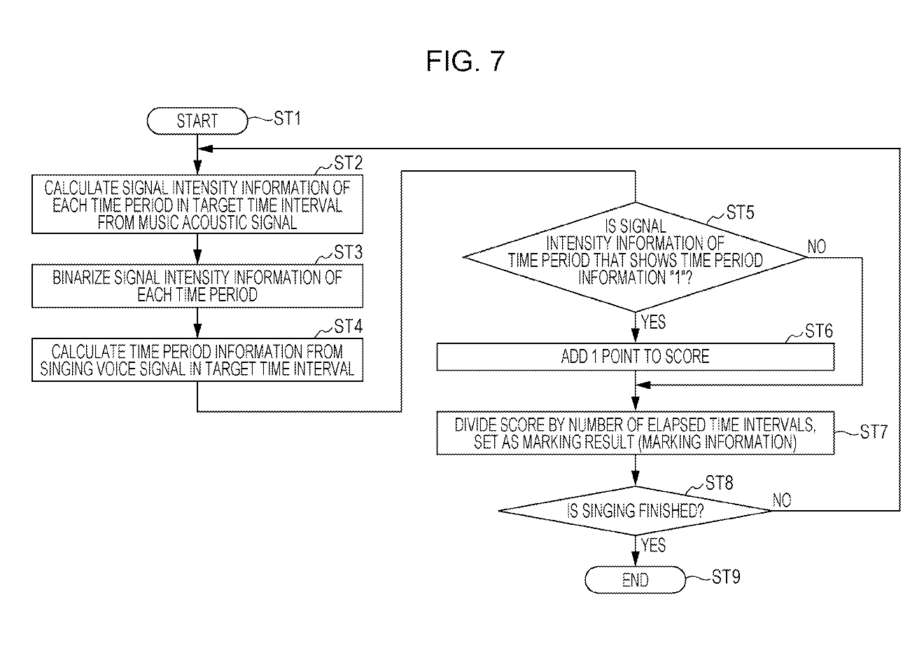

The flowchart in FIG. 7 shows one example of a marking process procedure in marking example 1 of the marking processing portion 12. The marking processing portion 12 begins the marking process in Step ST1, and thereafter moves to the process in Step ST2. In Step ST2, the marking processing portion 12 calculates the signal intensity information of each time period in the target time interval of the music acoustic signal with the pitch feature amount analyzer 111. Then, the marking processing portion 12, in Step ST3, binarizes the signal intensity information of each time period calculated in Step ST2 with the singing voice marking portion 114 (refer to FIG. 6(b)).

Next, the marking processing portion 12, in Step ST4, calculates the time period information in the target time interval of the singing voice signal with the pitch detector 113 (refer to FIG. 6(a)). The marking processing portion 12, in Step ST5, among the signal intensity information of each time period binarized in Step ST3 determines whether or not the signal intensity information of the time period which the time period information calculated in Step ST4 shows is “1” with the singing voice marking portion 114. When the signal intensity information is “1”, the marking processing portion 12, in Step ST6, adds one point to the score with the singing voice marking portion 114, and thereafter, moves to the process in Step ST7. Meanwhile, when the signal intensity information is “0”, the marking processing portion 12 moves immediately to the process in Step ST7.

The marking processing portion 12, in Step ST7, divides the score with the number of elapsed time intervals with the singing voice marking portion 114, setting the marking result (marking information). The marking processing portion 12, in Step ST8, determines whether the singing is finished. The marking processing portion 12, for example, determines the finish of singing when the user performs a finishing operation from an operation portion not shown in the drawings, or when the accompaniment audio finishes. When the singing is not finished, the marking processing portion 12 returns to the process in Step ST2, and moves to the process setting the next time interval to the target time interval. Meanwhile, when the singing is finished, the marking processing portion 12 immediately finishes the marking process in Step ST9.

In the marking process in the flowchart in FIG. 7, all of the time intervals become the time interval of the marking target; however, for example, a time interval of an intermission period or a time interval in which no singing voice is input, or the like, may be configured so as to be excluded from the time interval of the marking target.

### Marking Process Example 2

In marking process example 2, the signal intensity information for each time period is calculated as a pitch feature amount of the music acoustic signal for each predetermined time interval by the pitch feature amount analyzer 111, and the signal intensity information is used as is in the singing voice marking portion 114. In marking process example 2, time period information that is the pitch feature amount of the singing voice signal for each predetermined time interval is calculated by the pitch detector 113, and the time period information thereof is used in the singing voice marking portion 114.

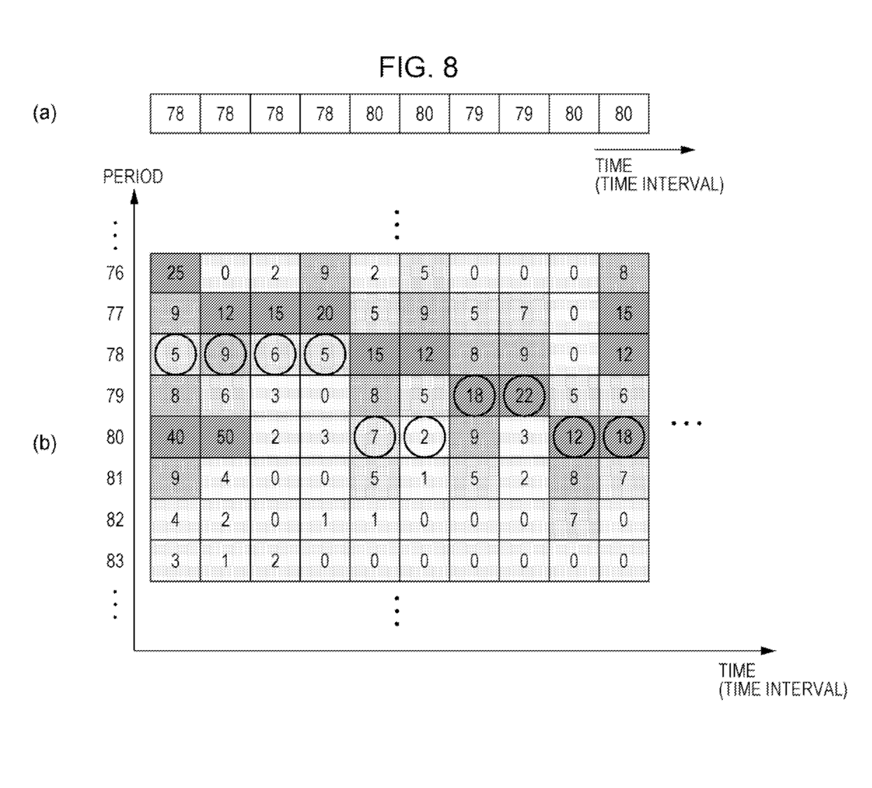

FIG. 8(b) shows an example of signal intensity information of each time period for each time interval of the music acoustic signal. FIG. 8(a) shows an example of time period information for each time interval of a singing voice signal. In FIG. 8(b), in each time segment, locations of the time period which the time period information of the singing voice signal shows are indicated by applying a “0” mark.

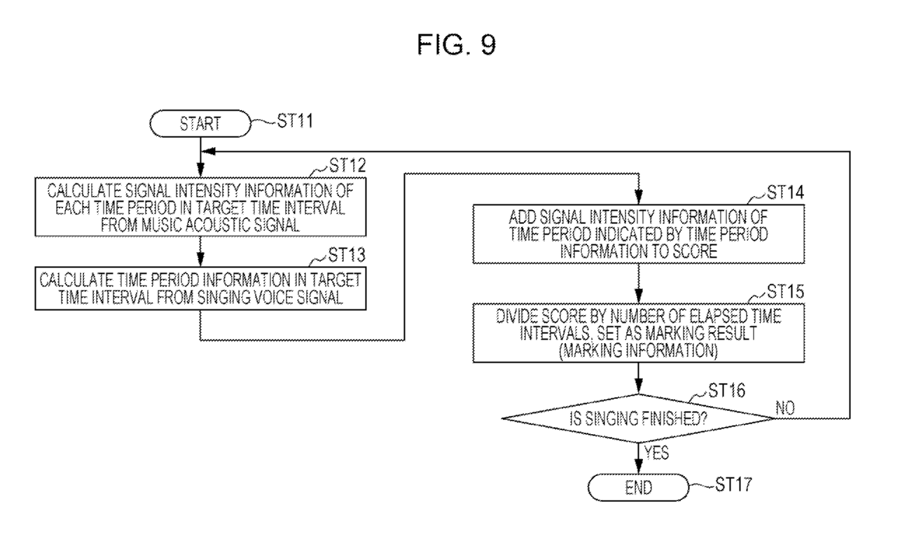

The flowchart in FIG. 9 is one example of a marking process procedure in marking process example 2 of the marking processing portion 12. The marking processing portion 12 begins the marking process in Step ST11, and thereafter moves to the process in Step ST12. In Step ST12, the marking processing portion 12 calculates the signal intensity information of each time period in the target time interval of the music acoustic signal with the pitch feature amount analyzer 111 (refer to FIG. 8(b)). The marking processing portion 12, in Step ST13, calculates the time period information in the target time interval of the singing voice signal with the pitch detector 113 (refer to FIG. 8(a)).

Next, the marking processing portion 12, in Step ST14, adds signal intensity information of the time period which time period information shows calculated in Step ST13 from among the signal intensity information of each time period calculated in Step ST12 to the score with the singing voice marking portion 114. The marking processing portion 12, in Step ST15, divides the score with the number of elapsed time intervals with the singing voice marking portion 114, and sets the marking result (marking information).

Next, the marking processing portion 12, in Step ST16, determines whether the singing is finished. The marking processing portion 12, for example, determines the finish of singing when the user performs a finishing operation from an operation portion not shown in the drawings, or when the accompaniment audio finishes. When the singing is not finished, the marking processing portion 12 returns to the process in Step ST12, and moves to the process setting the next time interval to the target time interval. Meanwhile, when the singing is finished, the marking processing portion 12 immediately finishes the marking process in Step ST17.

In the marking process in the flowchart in FIG. 9, all of the time intervals become the time interval of the marking target; however, for example, a time interval of an intermission period or a time interval in which no singing voice is input, or the like, may be configured so as to be excluded from the time interval of the marking target.

### Marking Process Example 3

In marking process example 3, the signal intensity information for each time period is calculated as a pitch feature amount of the music acoustic signal for each predetermined time interval by the pitch feature amount analyzer 111, and binarized information of the signal intensity information is used in the singing voice marking portion 114. In marking process example 3, time period information that is the pitch feature amount of the singing voice signal for each predetermined time interval is calculated by the pitch detector 113, and the doubled time period information thereof is used in the singing voice marking portion 114 along with the time period information thereof.

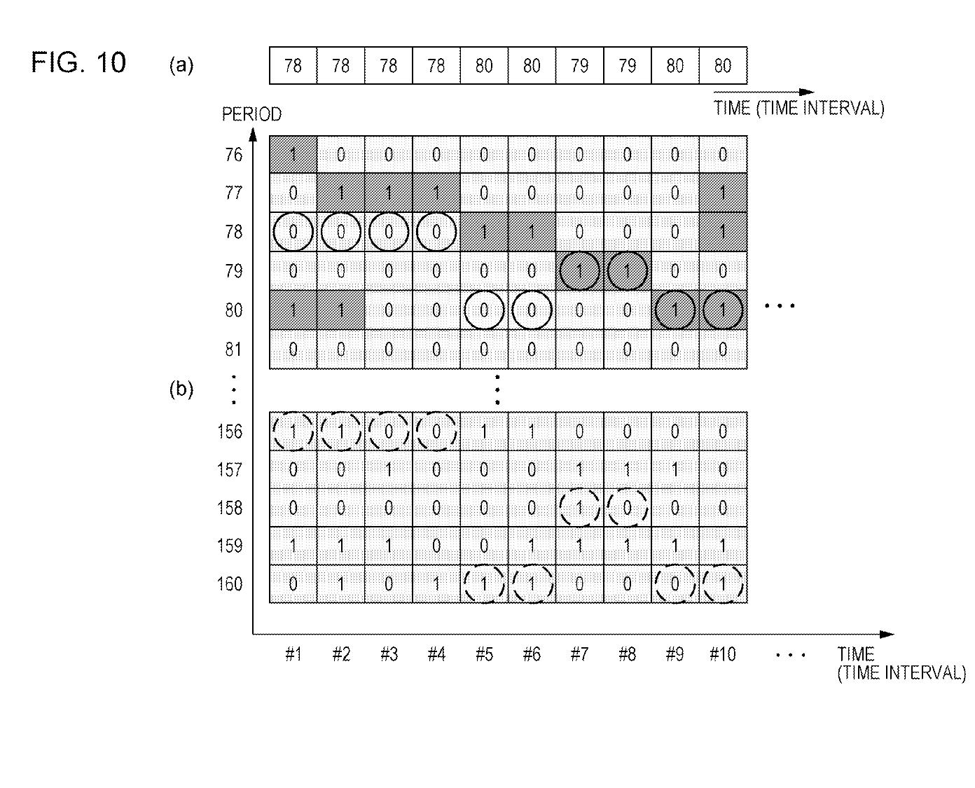

FIG. 10(b) shows an example of binarized signal intensity information of each time period for each time interval of a music acoustic signal. FIG. 10(a) shows an example of time period information for each time interval of a singing voice signal. In FIG. 10(b), in each time interval, locations of the time period which the time period information of the singing voice signal shows are indicated by applying a “O” mark with a solid line, and locations of the doubled time period of the time period are indicated by applying a “O” with a broken line.

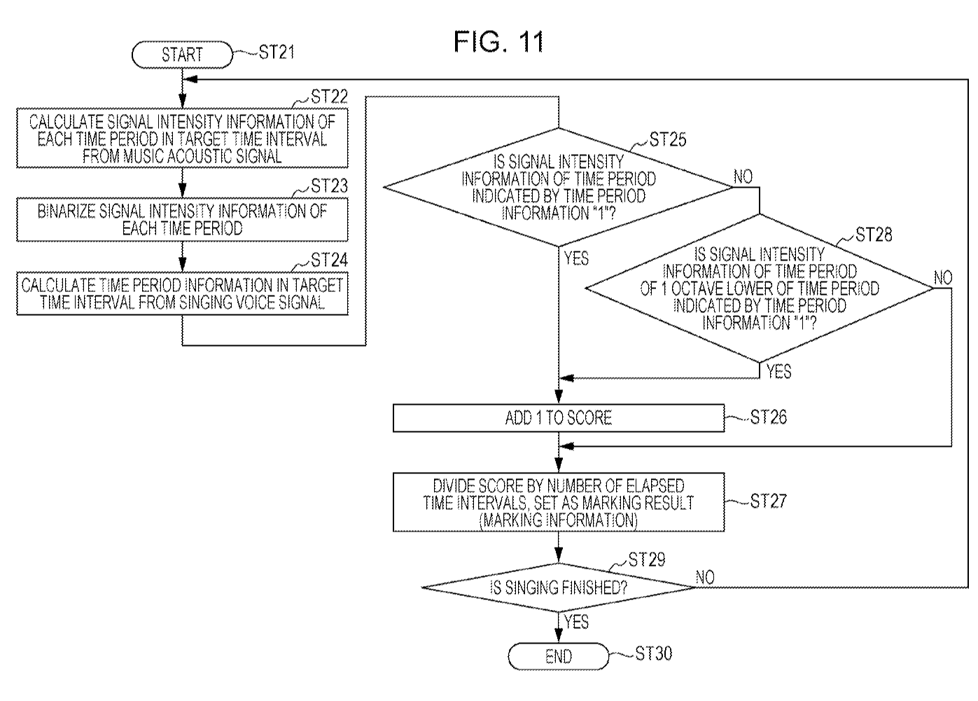

The flowchart in FIG. 11 shows an example of a marking process procedure in marking example 3 of the marking processing portion 12. The marking processing portion 12 begins the marking process in Step ST21, and thereafter moves to the process in Step ST22. In Step ST22, the marking processing portion 12 calculates the signal intensity information of each time period in the target time interval of the music acoustic signal with the pitch feature amount analyzer 111. The marking processing portion 12, in Step ST23, binarizes the signal intensity information of each time period calculated in Step ST22 with the singing voice marking portion 114 (refer to FIG. 10(b)).

Next, the marking processing portion 12, in Step ST24, calculates the time period information in the target time interval of the singing voice signal with the pitch detector 113 (refer to FIG. 10(a)). The marking processing portion 12, in Step ST25, determines whether the signal intensity information of the time period which the time period information calculated in Step ST24 shows is “1” from among the signal intensity information of each time period binarized in Step ST23 with the singing voice marking portion 114. When the signal intensity information is “1”, the marking processing portion 12, in Step ST26, adds one point to the score with the singing voice marking portion 114, and thereafter, moves to the process in Step ST27.

When the signal intensity information is “0” in Step ST25, the marking processing portion 12, in Step ST28, determines whether the time period that is double the time period which the time period information calculated in Step 24 shows, that is, the time period of one octave lower is “1”. When the signal intensity information is “1”, the marking processing portion 12, in Step ST26, adds one point to the score with the singing voice marking portion 114, and thereafter, moves to the process in Step ST27. Meanwhile, when the signal intensity information is “0”, the marking processing portion 12 moves immediately to the process in Step ST27.

The marking processing portion 12, in Step ST27, divides the score with the number of elapsed time intervals with the singing voice marking portion 114, and sets the marking result (marking information). The marking processing portion 12, in Step ST29, determines whether the singing is finished. The marking processing portion 12, for example, determines the finish of singing when the user performs a finishing operation from an operation portion not shown in the drawings, or when the accompaniment audio finishes. When the singing is not finished, the marking processing portion 12 returns to the process in Step ST22, and moves to the process setting the next time interval to the target time interval. Meanwhile, when the singing is finished, the marking processing portion 12 immediately finishes the marking process in Step ST30.

In the marking process in the flowchart in FIG. 11, all of the time intervals become the time interval of the marking target; however, for example, a time interval of an intermission period or a time interval in which no singing voice is input, or the like, may be configured so as to be excluded from the time interval of the marking target.

The operation of the marking processing portion 12 shown in FIG. 2 will be described. The music acoustic signal is analyzed with the pitch feature amount analyzer 111, and the pitch feature amount of the music acoustic signal (musical composition audio) for each predetermined time interval, for example, the signal intensity information of each time period is calculated. A user begins singing, and a pitch feature amount of the singing voice signal for each predetermined time interval, for example, time period information is calculated from the singing voice signal by the pitch detector 113. The marking information is calculated and output by the singing voice marking portion 114 by comparison of the pitch feature amount of the music acoustic signal obtained by the pitch feature amount analyzer 111 and the pitch feature amount of the singing voice signal obtained by the pitch detector 113.

[Reducing Process of Accompaniment Audio Creeping from Speaker]

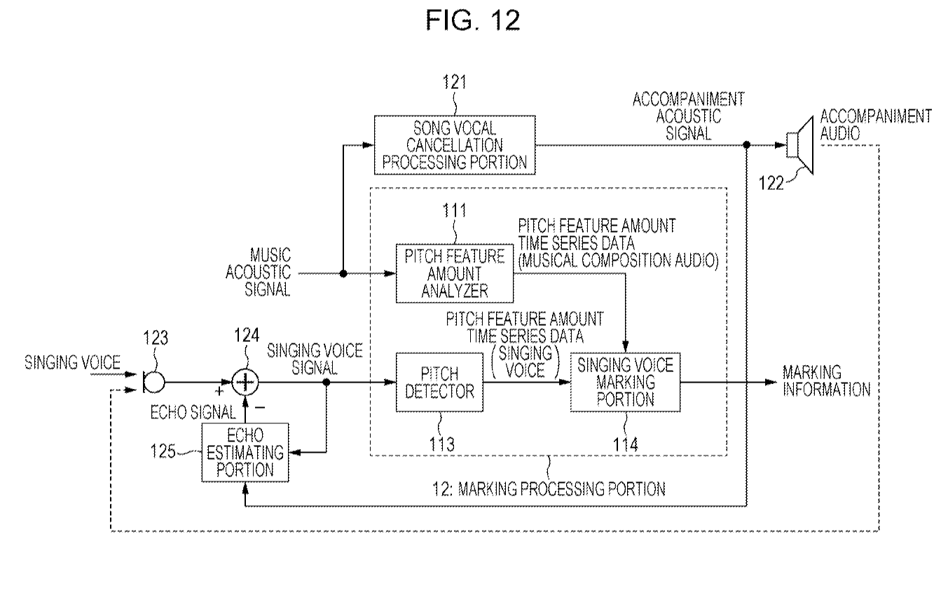

It is assumed that singing is performed while accompaniment audio is output in a space by the music acoustic signal. In this case, an additional processing configuration such as shown in FIG. 12 is considered with respect to the marking processing portion 12 shown in FIG. 2 described above. In FIG. 12, portions corresponding to FIG. 2 are given the same references, and a detailed description thereof will not be made, as appropriate.

The music acoustic signal is supplied to a song vocal cancellation processing portion 121, in addition to the pitch feature amount analyzer 111. In the song vocal cancellation processing portion 121, the vocal signal is canceled from the music acoustic signal, and the accompaniment acoustic signal is obtained. The accompaniment audio signal is supplied to the speaker 122, and the accompaniment audio is output from the speaker 122.

To the microphone 123, the singing voice is input, and accompaniment audio creeping from the speaker 122 is also input. Therefore, for the output signal of the microphone 123, an echo signal due to the accompaniment audio is added to the singing voice signal. For the echo estimating portion 125, the space propagation characteristics (echo characteristics) between the speaker and microphone are realized by adaptive filter process or the like, and an echo signal corresponding to the echo signal included in the singing voice signal is generated based on the accompaniment audio signal or the like. In the adder 124, the echo signal generated by the echo estimating portion 125 is subtracted from the output signal of the microphone 123. The singing voice signal from which the echo signal is removed is output from the adder 124, and input to the pitch detector 113.

In the additional processing configuration such as shown in FIG. 12, it is possible for the echo signal due to the accompaniment audio to be removed from the output signal of the microphone 123 by the adder 124, and for only the singing voice signal to be input to the pitch detector 113. Therefore, it is possible to reduce the influence of the creeping of accompaniment audio from the speaker 122 to the microphone 123. That is, it is possible to improve the calculation of the pitch feature amount in the pitch detector 113, for example, the calculation precision of the time period information or the like of the singing voice signal.

Configuring the marking processing portion 12 shown in FIG. 2 by a user side client apparatus 12A and a cloud-based (network) server apparatus 12B will be considered. In this case, it is possible to reduce the processing burden and circuit scale of the client-side (user) apparatus.

### Configuration by Client Apparatus and Server Apparatus of the Marking Processing Portion

### Configuration Example 1

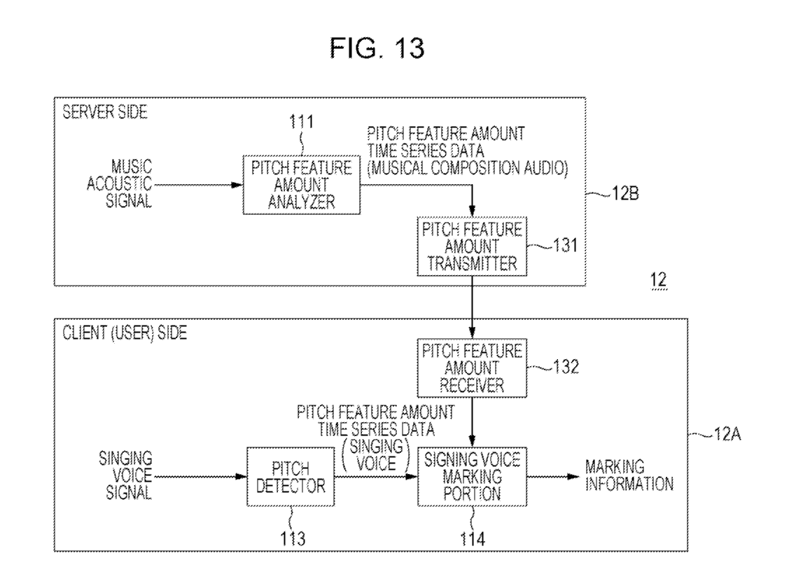

FIG. 13 shows configuration example 1 of the marking processing portion 12 configured by a client apparatus 12A and a server apparatus 12B. Configuration Example 1 is an example in which analysis of the music acoustic signal is performed by the server apparatus 12B. In FIG. 13, portions corresponding to FIG. 2 are given the same references, and a detailed description thereof will not be made, as appropriate.

The server apparatus 12B includes a pitch feature amount analyzer 111 and a pitch feature amount transmitter 131. The pitch feature amount analyzer 111 calculates the pitch feature amount of the music acoustic signal for each predetermined time interval, for example, the signal intensity information of each time period by analyzing the music acoustic signal. The pitch feature amount transmitter 131 transmits time series data of the pitch feature amount obtained with the pitch feature amount analyzer 111 to the client apparatus 12A. Although the instruction path is not shown, an analysis instruction is transmitted from the client apparatus 12A to the server apparatus 12B before singing, and analysis of the music acoustic signal is begun in the server apparatus 12B based on the analysis instruction.

The client apparatus 12A includes a pitch detector 113, a singing voice marking portion 114, and a pitch feature amount receiver 132. The pitch detector 113 calculates a pitch feature amount of the singing voice signal for each predetermined time interval, for example, time period information from the singing voice signal. The voice feature amount receiver 132 received time series data of the pitch feature amount that is transmitted from the server apparatus 12B. The singing voice marking portion 114 calculates and outputs the marking information indicating the similarity between acoustic signals by comparison of the pitch feature amount of the music acoustic signal received by the pitch feature amount receiver 132 and the pitch feature amount of the singing voice signal obtained by the pitch detector 113.

The operation of the marking processing portion 12 (configuration example 1) shown in FIG. 13 will be simply described. An analysis instruction of the pitch feature amount of the musical composition audio is transmitted from the client apparatus 12A to the server apparatus 12B before singing. In the server apparatus 12B, the music acoustic signal is analyzed with the pitch feature amount analyzer 111, and the pitch feature amount of the music acoustic signal for each predetermined time interval, for example, the signal intensity information of each time period is calculated. The time series data of the pitch feature amount calculated in this way is transmitted from the pitch feature amount transmitter 131 of the server apparatus 12B to the client apparatus 12A, and is received by the pitch feature amount receiver 132 of the client apparatus 12A.

In the client apparatus 12A, singing by the client (user) is begun. The pitch feature amount of the singing voice signal for each predetermined time interval, for example, time period information is calculated from the singing voice signal by the pitch detector 113. In the client apparatus 12A, the marking information is calculated by the singing voice marking portion 114 by comparison of the pitch feature amount of the music acoustic signal received by the pitch feature amount receiver 132 and the pitch feature amount of the singing voice signal obtained by the pitch detector 113. In so doing, acquisition of the marking information is performed with the client apparatus 12A.

In the marking processing portion 12 (configuration example 1) shown in FIG. 13, it is possible to reduce the processing burden and circuit scale of the client-side (user) apparatus. In a music delivery service, or the like, on the server side, pitch feature amount time series data of the music acoustic signal is able to be provided to the user as an added value. In a network delivery-type karaoke service, it is possible to automatically create the correct answer data for marking (melody data) manually created in the related art.

### Configuration Example 2

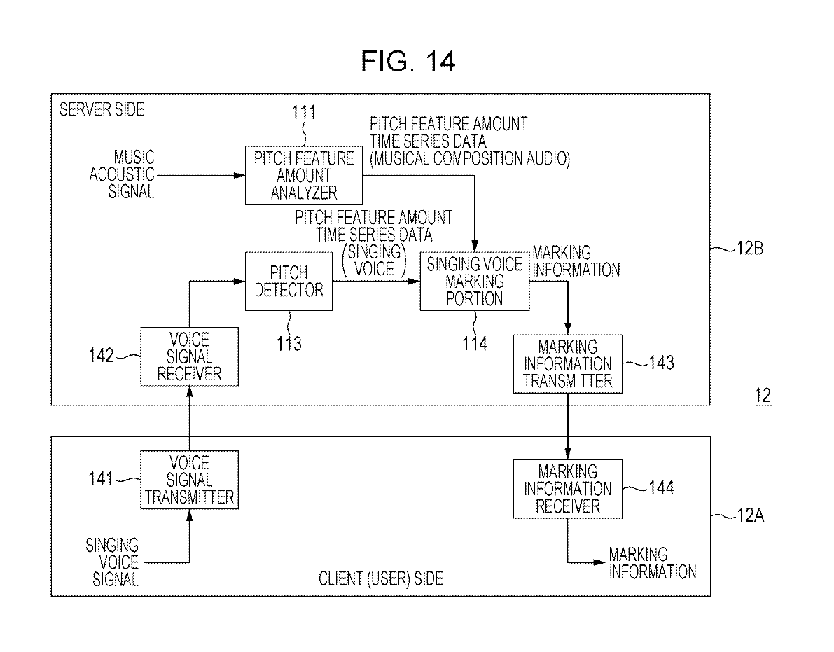

FIG. 14 shows configuration example 2 of the marking processing portion 12 configured by a client apparatus 12A and a server apparatus 12B. Configuration Example 2 is an example in which pitch detection of the singing voice signal and the marking process are further performed by the server apparatus 12B, along with performing analysis of the music acoustic signal. In FIG. 14, portions corresponding to FIG. 2 are given the same references, and a detailed description thereof will not be made, as appropriate.

The server apparatus 12B includes the pitch feature amount analyzer 111, the pitch detector 113, the singing voice marking portion 114, a voice signal receiver 142, and a marking information transmitter 143. The pitch feature amount analyzer 111 calculates the pitch feature amount of the music acoustic signal for each predetermined time interval, for example, the signal intensity information of each time period by analyzing the music acoustic signal. Although the instruction path is not shown, an analysis instruction is transmitted from the client apparatus 12A to the server apparatus 12B before singing, and analysis of the music acoustic signal is begun in the server apparatus 12B based on the analysis instruction.

The voice signal receiver 142 receives the singing voice signal transmitted from the client apparatus 12A. The pitch detector 113 calculates the pitch feature amount of the singing voice signal for each predetermined time interval, for example, the time period information from the singing voice signal received by the voice signal receiver 142. The singing voice marking portion 114 calculates the marking information indicating the similarity between acoustic signals by comparison of the pitch feature amount of the music acoustic signal obtained by the pitch feature amount analyzer and the pitch feature amount of the singing voice signal obtained by the pitch detector 113. The marking information transmitter 143 transmits the marking information calculated with the singing voice marking portion 114 to the client apparatus 12A.

The client apparatus 12A includes the voice signal transmitter 141 and the marking information receiver 144. The voice signal transmitter 141 transmits the singing voice signal to the server apparatus 12B. The marking information receiver 144 receives the marking information transmitted from the server apparatus 12B.

The operation of the marking processing portion 12 (configuration example 2) shown in FIG. 14 will be simply described. An analysis instruction of the pitch feature amount of the musical composition audio is transmitted from the client apparatus 12A to the server apparatus 12B before singing. In the server apparatus 12B, the music acoustic signal is analyzed with the pitch feature amount analyzer 111, and the pitch feature amount of the music acoustic signal for each predetermined time interval, for example, the signal intensity information of each time period is calculated.

In the client apparatus 12A, singing by the client (user) is begun. The singing voice signal is transmitted from the voice signal transmitter 141 of the client apparatus 12A and received by the voice signal receiver 142 of the server apparatus 12B. In the server apparatus 12B, the pitch feature amount of the singing voice signal for each predetermined time interval, for example, the time period information is calculated from the singing voice signal received in this way by the pitch detector 113.

In the server apparatus 12B, the marking information is calculated by the singing voice marking portion 114 by comparison of the pitch feature amount of the music acoustic signal obtained by the pitch feature amount analyzer 111 and the pitch feature amount of the singing voice signal obtained by the pitch detector 113. The marking information calculated in this way is transmitted from the marking information transmitter 143 of the server apparatus 12B, received by the marking information receiver 144 of the client apparatus 12A, and acquisition of the marking information is performed by the client apparatus 12A.

In the marking processing portion 12 (configuration example 2) shown in FIG. 14, it is possible to significantly reduce the processing burden and circuit scale of the client-side (user) apparatus.

### Configuration Example 3

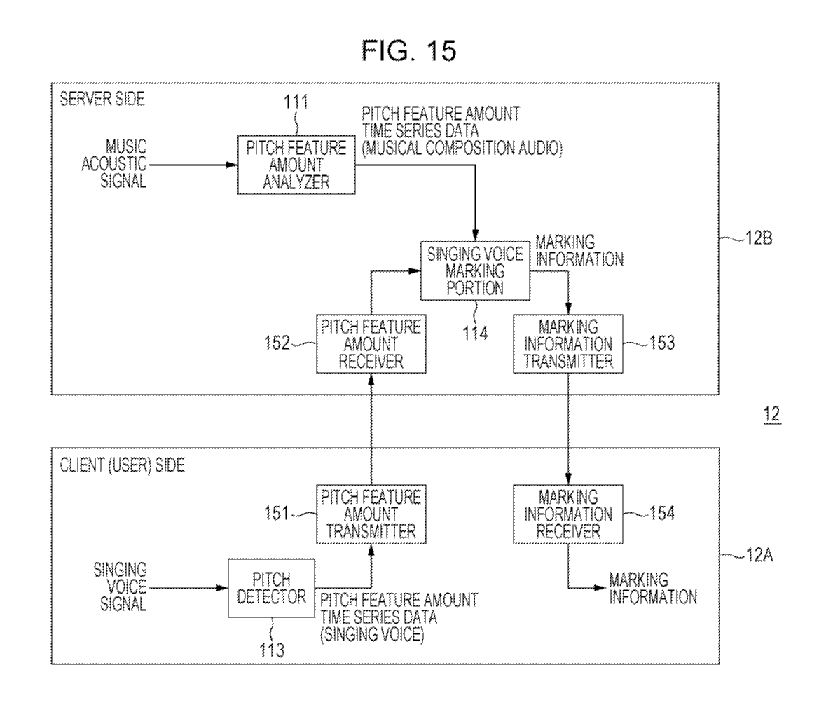

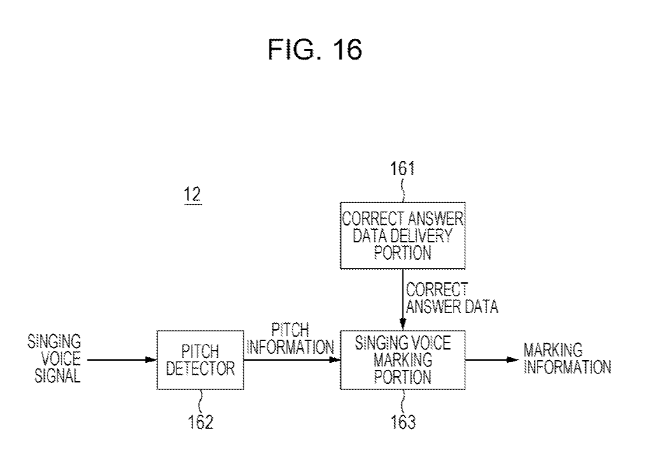

FIG. 15 shows configuration example 3 of the marking processing portion 12 configured by a client apparatus 12A and a server apparatus 12B. Configuration Example 3 is an example in which the marking process is also performed by the server apparatus 12B, along with analysis of the music acoustic signal. In FIG. 15, portions corresponding to FIG. 2 are given the same references, and a detailed description thereof will not be made, as appropriate.

The server apparatus 12B includes the pitch feature amount analyzer 111, the singing voice marking portion 114, a pitch feature amount receiver 152, and a marking information transmitter 153. The pitch feature amount analyzer 111 calculates the pitch feature amount of the music acoustic signal for each predetermined time interval, for example, the signal intensity information of each time period by analyzing the music acoustic signal. Although the instruction path is not shown, an analysis instruction is transmitted from the client apparatus 12A to the server apparatus 12B before singing, and analysis of the music acoustic signal is begun in the server apparatus 12B based on the analysis instruction.

The pitch feature amount receiver 152 receives time series data of the pitch feature amount of the singing voice signal transmitted from the client apparatus 12A. The singing voice marking portion 114 calculates the marking information indicating the similarity between acoustic signals by comparison of the pitch feature amount of the singing voice signal received by the pitch feature amount receiver 152 and the pitch feature amount of the music acoustic signal obtained with the pitch feature amount analyzer 111. The marking information transmitter 153 transmits the marking information calculated with the singing voice marking portion 114 to the client apparatus 12A.

The client apparatus 12A includes the pitch detector 113, the pitch feature amount transmitter 151 and the marking information receiver 154. The pitch detector 113 calculates a pitch feature amount of the singing voice signal for each predetermined time interval, for example, time period information from the singing voice signal. The pitch feature amount transmitter 151 transmits time series data of the pitch feature amount obtained with the pitch detector 113 to the server apparatus 12B. The marking information receiver 154 receives the marking information transmitted from the server apparatus 12B.

The operation of the marking processing portion 12 (configuration example 3) shown in FIG. 15 will be simply described. An analysis instruction of the pitch feature amount of the musical composition audio is transmitted from the client apparatus 12A to the server apparatus 12B before singing. In the server apparatus 12B, the music acoustic signal is analyzed with the pitch feature amount analyzer 111, and the pitch feature amount of the music acoustic signal for each predetermined time interval, for example, the signal intensity information of each time period is calculated.

In the client apparatus 12A, singing by the client (user) is begun. In the client apparatus 12A, the pitch feature amount of the singing voice signal for each predetermined time interval, for example, the time period information is calculated by the pitch detector 113. The time series data of the pitch feature amount of the singing voice signal is transmitted from the pitch feature amount transmitter 151 of the client apparatus 12A, and received by the pitch feature amount receiver 152 of the server apparatus 12B.

In the server apparatus 12B, the marking information is calculated by the singing voice marking portion 114 by comparison of the pitch feature amount of the music acoustic signal obtained by the pitch feature amount analyzer 111 and the pitch feature amount of the singing voice signal received by the pitch feature amount receiver 152. The marking information calculated in this way is transmitted from the marking information transmitter 153 of the server apparatus 12B, received by the marking information receiver 154 of the client apparatus 12A, and acquisition of the marking information is performed by the client apparatus 12A.

In the marking processing portion 12 (configuration example 3) shown in FIG. 15, it is possible to significantly reduce the processing burden and circuit scale of the client-side (user) apparatus. Compared to the above-described configuration example 2, the size of the data transmitted from the client apparatus 12A to the server apparatus 12B is reduced.

As described above, in the marking processing portion 12 shown in FIG. 2, the similarity (marking information) is obtained by comparison of the pitch feature amount of the music acoustic signal calculated from the music acoustic signal and the pitch feature amount of the singing voice calculated from the singing voice signal. Therefore, it is possible to mark karaoke using commercial musical content.

### [Another Configuration Example of Marking Processing Portion]

The configuration example of the marking processing portion 12 showing FIG. 2 is able to perform marking using the music acoustic signal. However, the marking processing portion 12 in the karaoke apparatus 10 shown in FIG. 1 may have another configuration, for example, a configuration known in the related art. FIG. 16 shows another configuration example of the marking processing portion 12.

The marking processing portion 12 includes a correct answer data delivery portion 161, the pitch detector 162, and a singing voice marking portion 163. The pitch detector 162 detects pitch information of the singing voice signal for each predetermined time interval (short time interval), and inputs the information to the singing voice marking portion 163. Here, the pitch information is the basic frequency obtained by analyzing the periodicity of the singing voice signal for each short time interval, or is converted to a pitch name by quantization thereof.

The correct answer data delivery portion 161 delivers the correct answer data to the singing voice marking portion 163 while taking the pitch information and the time synchronization. Here, the correct answer data is the basic frequency that is a model or is converted to a pitch name by quantization thereof that is included in the time series data. The singing voice marking portion 163 compares the pitch information and the correct answer information, performs scoring according to a match or the closeness of the value thereof, and obtains the marking information.

The operation of the marking processing portion 12 shown in FIG. 16 will be described. The singing voice signal corresponding to the singing voice of the user is supplied to the pitch detector 162. In the pitch detector 162, pitch information of the singing voice signal for each predetermined time interval (short time interval) is detected, and is input to the singing voice marking portion 163. The correct answer data is input to the singing voice marking portion 163 from the correct answer data delivery portion 161 while taking the pitch information and the time sychronization. In the singing voice marking portion 163, scoring is performed by the pitch information and the correct answer data being compared, and the marking information is obtained.

### [Configuration Example of Acoustic Effect Application Portion]

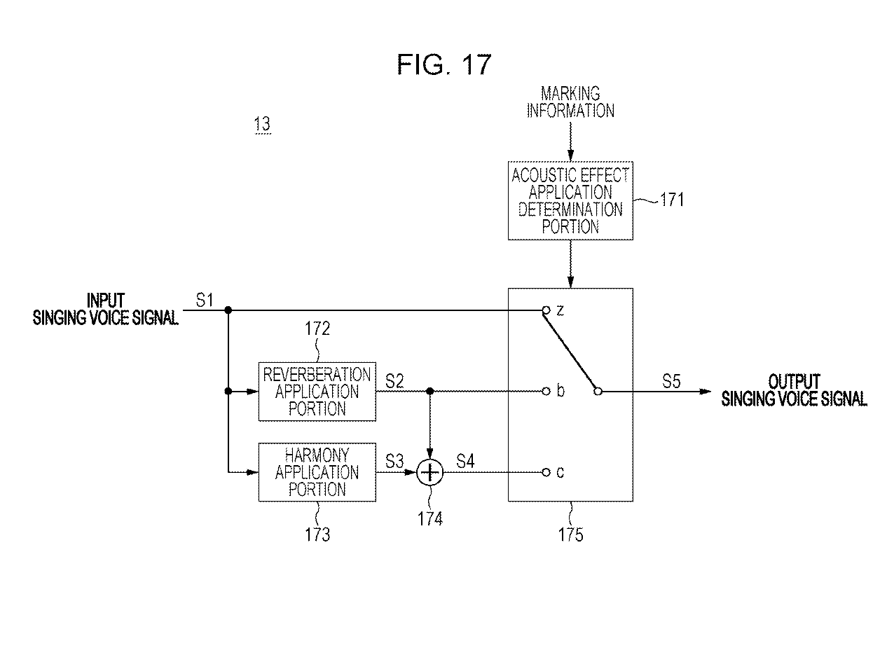

FIG. 17 shows a configuration example of an acoustic effect application portion 13 in the karaoke apparatus 10 shown in FIG. 1. The acoustic effect application portion 13 includes an acoustic effect application determining portion 171, a reverberation application portion 172, a harmony application portion 173, an addition portion 174, and a switch portion 175. The reverberation effect application portion 172 inputs the singing voice signal S1, applies reverberation, such as an echo (reverb), to the singing voice signal S1 by signal processing, such as a filter, and generates the reverberation application signal S2.

The harmony application portion 173 inputs the singing voice signal S1, and generates the harmony application signal S3 by applying a converted signal to the key (for example, a third or a fifth) that is matched when synthesized with the singing voice signal S1. The addition portion 174 adds the reverberation application signal S2 generated with the reverberation application portion 172 to the harmony application signal S3 generated with the harmony application portion 173, and a reverberation and harmony application signal S4 is obtained.

The acoustic effect application determining portion 171 performed a threshold determining process, as below, with respect to the marking information obtained by the marking processing portion 12 (refer to FIG. 1), switches the switch portion 175 according to the number of points, and switches the output singing voice signal S5. Below, α and β are each thresholds. In the switch portion 175, the input singing voice signal S1 is supplied to the a terminal, the reverberation application signal S2 is supplied to the b terminal, and the reverberation and harmony application signal S4 is supplied to the c terminal.

The acoustic effect application determining portion 171 is set such that the connection of the switch portion 175 switches to terminal a when the score<α, and the input singing voice signal S1 is output as an output singing voice signal S5. The acoustic effect application determining portion 171 is set such that the connection of the switch portion 175 switches to the b terminal when α≦score<β, and the reverberation application signal S2 is output as the output singing voice signal S5. Furthermore, the acoustic effect application determining portion 171 is set such that the connection of the switch portion 175 switches to the c terminal when β≦score, and the reverberation and harmony application signal S4 is output as the output singing voice signal S5.

The operation of the acoustic effect application portion 13 shown in FIG. 17 will be described. The input singing voice signal S1 is supplied to each of the reverberation application portion 172, the harmony application portion 173 and the a terminal of the switch portion 175. In the reverberation application portion 172, the singing voice signal S1 is subjected to signal processing, such as a filter, and the reverberation application signal S2 is generated in which reverberation, such as an echo (reverb) is applied. The reverberation application signal S2 is supplied to the b terminal of the switch portion 175.

In the harmony application portion 173, the harmony application signal S3 is generated by a converted signal being applied to the key (for example, a third or a fifth) that is matched with the singing voice signal S1 when synthesized therewith. The harmony application signal S3 and the above-described reverberation application signal S2 are added with the addition portion 174, and the harmony and reverberation application signal S4 is obtained. The harmony and reverberation application signal S4 is supplied to the c terminal of the switch portion 175.

The marking information is supplied to the acoustic effect application determining portion 171. In the acoustic effect application determining portion 171, a threshold determining process is performed with respect to the marking information, and switching of the switch portion 175 is controlled. When the score<α, and the score is low, the connection of the switch portion 175 is switched to the a terminal, and the input singing voice signal S1 is set as is to the output singing voice signal S5. When α≦score<β, and the score is intermediate, the connection of the switch portion 175 is switched to the b terminal, and the reverberation application signal S2 is set to the output singing voice signal S5. When β≦score, and the score is high, the connection of the switch portion 175 is switched to the c terminal, and the reverberation and harmony application signal S4 is set to the output singing voice signal S5.

In the acoustic effect application portion 13 shown in FIG. 17, it is possible to expect a richer acoustic effect being superimposed as the score of the singing increases, thereby elevating the feeling of the singer. In other words, by applying the acoustic effect in real time according to the singing ability of the singer, it is possible to provide auditory excitement with respect to the singer, and possible to increase the usage value of karaoke by arousing the feeling of challenge of further improving a song without losing interest. In the acoustic effect application portion 13, only singers in a state in which the singing ability is stabilized to a certain extent use harmony, and it is possible for not only the singer, but also the audience to more comfortably enjoy karaoke.

The acoustic effect application portion 13 shown in the above-described FIG. 17 selectively outputs any of the input singing voice signal S1, the reverberation application signal S2 or the reverberation and harmony application signal S3 as the output singing voice signal S5 according to the marking information. However, applying a continuous effect according to the marking information may also be considered.

For example, setting the marking information (score) to SCORE (maximum 100 points), setting α and β (where α<β) as thresholds, and adding the effect as below to the singing voice signal are considered.

(1) If SCORE<α, the output singing voice signal S5 is switched to the input singing voice signal S1.

(2) If α≦SCORE<β, the output singing voice signal S5 is switched to the reverberation application signal S2 in which the intensity of the reverberation is controlled according to the SCORE as below. In this case, when the intensity of the reverberation is set to RLev (0 to 1.0), RLev=SCORE÷100.

(3) If β≦SCORE, the output singing voice signal S5 is switched to the reverberation and harmony application signal S3 in which the intensity of the reverberation and the harmony is controlled according to the SCORE as below. In this case, when the intensity of the reverberation is set to RLev (0 to 1.0), RLev=SCORE÷100. In this case, when the intensity of the harmony is set to HLev (0 to 1.0), HLev=SCORE÷100.

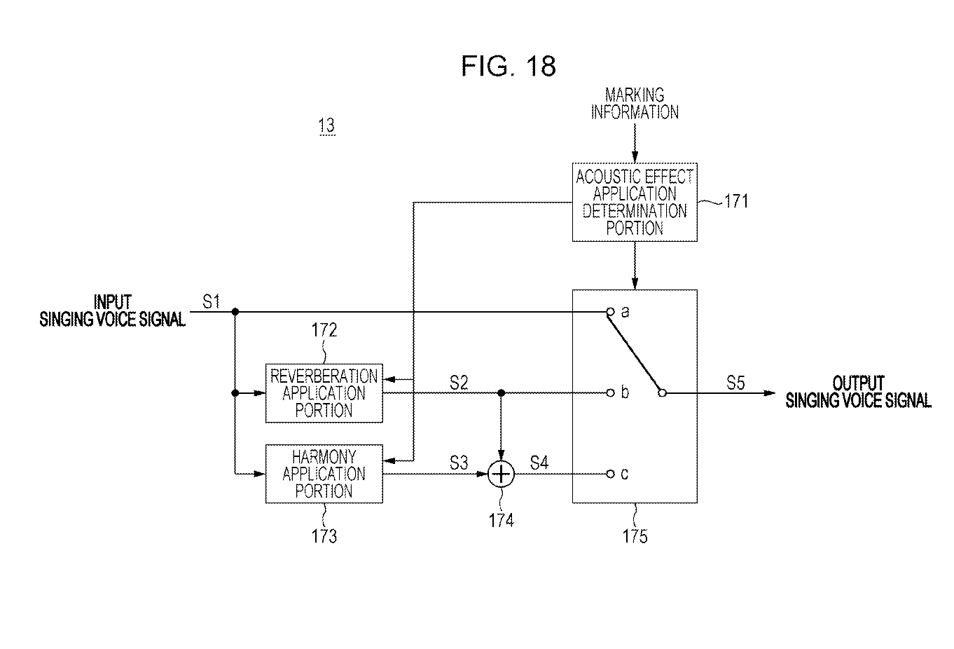

FIG. 18 shows a configuration example of an acoustic effect application portion 13 in a case of applying a continuous effect according to the marking information in this way. In this case, the intensity of the harmony of the harmony application portion 173 is controlled as described above by the acoustic effect application determining portion 171, along with the intensity of the reverberation of the reverberation application portion 172 being controlled, as described above.

The acoustic effect application portion 13 shown in the above-described FIG. 17 is an example that applies an acoustic effect as the score of the singing increases. However, conversely, applying the acoustic effect as the score decreases is also considered. For example, setting the marking information (score) to SCORE (maximum 100 points), setting α as a threshold, and adding the effect as below to the singing voice signal are considered.

(1) If SCORE<α, the output singing voice signal S5 is switched to the reverberation application signal S2 in which the intensity of the reverberation is controlled according to the SCORE as below. In this case, when the intensity of the reverberation is set to RLev (0 to 1.0), RLev=(100−SCORE)÷100.

(2) If α≦SCORE, switching is performed to the reverberation and harmony application signal S3 in which the intensity of the reverberation and the harmony is controlled according to the SCORE as below. In this case, when the intensity of the reverberation is set to RLev (0 to 1.0), RLev=(100−SCORE)÷100. In this case, when the intensity of the harmony is set to HLev (0 to 1.0), HLev=SCORE÷100.

By adding echo (reverb) as the score decreases through this control, it is possible to cover off-key singers. Since harmony is discomforting in the case of an off-key singer, the intensity is suppressed as the score decreases.

As described above, in the karaoke apparatus 10 in FIG. 1, a predetermined acoustic effect is applied to the singing voice signal according to the results of the marking process (marking information) based on the singing voice signal, and it is possible to apply the acoustic effect in real time according to the singing ability of the singer.

### 2. Modification Examples

In the above-described embodiment, although an example in which the target comparison acoustic signal is the singing voice signal is shown, the present technology is not limited thereto, and cases of other acoustic signals, for example, musical instrument performance signals, or the like, are considered.

In the above-described embodiments, although description was made assuming a case of a single person singing as the singing voice signal, it is possible to perform the same marking process with respect to the singing voice signal in a case of two people singing in, for example, a duet piece. Naturally, three or more people is also possible.

In addition, in the above-described embodiments, it may not necessary to perform the process in which the pitch feature amount of the musical composition audio is obtained from the music acoustic signal by the pitch feature amount analyzer 111 in real time matching the singing, and the process may be performed in advance.

Here, the present technology may also adopt the following configuration.

(1) An acoustic processing apparatus including a first feature amount calculator that calculates a first pitch feature amount from a music acoustic signal for each predetermined time interval; a second feature amount calculator that calculates a second pitch feature amount from a target comparison acoustic signal for each time interval corresponding to the predetermined time interval; and a similarity calculator that calculates a similarity between acoustic signals by comparison of the first pitch feature amount and the second pitch feature amount.

(2) The acoustic processing apparatus according to (1), in which the target comparison acoustic signal is a singing voice signal.

(3) The acoustic processing apparatus according to (2), further including an acoustic effect application portion that applies a predetermined acoustic effect to the singing voice signal according to the similarity.

(4) The acoustic processing apparatus according to any one of (1) to (3), in which the first feature amount calculator calculates signal intensity information for each time period or each frequency of the music acoustic signal as a first pitch feature amount, and the second feature amount calculator calculates a time period or frequency of each signal component included in the target comparison acoustic signal as a second pitch feature amount.

(5) The acoustic processing apparatus according to (4), in which the similarity calculator binarizes and uses the signal intensity information as the first pitch feature amount.

(6) The acoustic processing apparatus according to (4) or (5), in which the similarity calculator uses, in addition to the time period or the frequency as the second pitch feature amount, a time period that is double the time period or a frequency that is ½ the frequency.

(7) An acoustic processing method including the steps of calculating a first pitch feature amount from a music acoustic signal for each predetermined time interval; calculating a second pitch feature amount from a target comparison acoustic signal for each time interval corresponding to the predetermined time interval; and calculating a similarity between acoustic signals by comparison of the first pitch feature amount and the second pitch feature amount.

(8) A program causing a computer to function as first feature amount calculating means for calculating a first pitch feature amount from a music acoustic signal for each predetermined time interval; second feature amount calculating means for calculating a second pitch feature amount from a target comparison acoustic signal for each time interval corresponding to the predetermined time interval; and similarity calculating means for calculating a similarity between acoustic signals by comparison of the first pitch feature amount and the second pitch feature amount.

(9) An electronic apparatus including an accompaniment audio output portion that performs output of accompaniment audio according to a music acoustic signal; an acoustic signal acquisition portion that acquires a target comparison acoustic signal; and a signal processing portion that performs comparison processing between the target comparison acoustic signal and the music acoustic signal, in which the signal processing portion includes a first feature amount calculator that calculates a first pitch feature amount from the music acoustic signal for each predetermined time interval, a second feature amount calculator that calculates a second pitch feature amount from the target comparison acoustic signal for each time interval corresponding to the predetermined time interval, and a similarity calculator that calculates a similarity between acoustic signals by comparison of the first pitch feature amount and the second pitch feature amount.

(10) An acoustic processing apparatus including a marking processing portion that performs a marking processes based on a singing voice signal; and an acoustic effect application portion that applies a predetermined acoustic effect to the singing voice signal according to a result of the marking process.

(11) The acoustic processing apparatus according to (10), in which the marking processing portion performs the marking process by calculating a similarity between a music acoustic signal and the singing voice signal.

(12) The acoustic processing apparatus according to (11), in which the marking processing portion includes a first feature amount calculator that calculates a first pitch feature amount from the music acoustic signal for each predetermined time interval, a second feature amount calculator that calculates a second pitch feature amount from the singing voice signal for each time interval corresponding to the predetermined time interval, and a similarity calculator that calculates a similarity between acoustic signals by comparison of the first pitch feature amount and the second pitch feature amount.

(13) A server apparatus including a first feature amount calculator that calculates a first pitch feature amount from a music acoustic signal for each predetermined time interval; and an information transmitter that transmits information based on the first pitch feature amount to a client apparatus.

(14) The server apparatus according to (13) further including an acoustic signal receiver that receives a target comparison acoustic signal from the client apparatus; a second feature amount calculator that calculates a second pitch feature amount from the target comparison acoustic signal for each time interval corresponding to the predetermined time interval; and a similarity calculator that calculates a similarity between acoustic signals by comparison of the first pitch feature amount and the second pitch feature amount, in which the information transmitter transmits the similarity to the client apparatus.

(15) The server apparatus according to (13) further including a feature amount receiver that receives a second pitch feature amount calculated from a target comparison acoustic signal for each time interval corresponding to the predetermined time interval from the client apparatus; and a similarity calculator that calculates a similarity between acoustic signals by comparison of the first pitch feature amount and the second pitch feature amount, in which the information transmitter transmits the similarity to the client apparatus.

(16) A client apparatus including an acoustic signal acquisition portion that acquires a target comparison acoustic signal; and a similarity acquisition portion that acquires a similarity between acoustic signals calculated by comparison between a first pitch feature amount calculated from a music acoustic signal for each predetermined time interval and a second pitch feature amount calculated from the target comparison acoustic signal for each time interval corresponding to the predetermined time interval.

(17) The client apparatus according to (16) further including a feature amount calculator that calculates the second pitch feature amount from the target comparison acoustic signal; a feature amount receiver that receives the first pitch feature amount from a server apparatus; and a similarity calculator that calculates a similarity between acoustic signals by comparison of the first pitch feature amount and the second pitch feature amount, in which the similarity acquisition portion acquires the similarity from the similarity calculator.

(18) The client apparatus according to (16) further including a feature amount calculator that calculates the second pitch feature amount from the target comparison acoustic signal; a feature amount transmitter that transmits the first pitch feature amount to a server apparatus; and a similarity receiver that receives the similarity from the server apparatus, in which the similarity acquisition portion acquired the similarity from the similarity receiver.

(19) An acoustic processing system including a server apparatus and a client apparatus, in which the server apparatus includes a feature amount calculator that calculates a first pitch feature amount from a music acoustic signal for each predetermined time interval, and an information transmitter that transmits information based on the first pitch feature amount to a client apparatus, and the client apparatus includes an acoustic signal acquisition portion that acquires a target comparison acoustic signal, and a similarity acquisition portion that acquires a similarity between acoustic signals calculated by comparison between the first pitch feature amount and a second pitch feature amount calculated from the target comparison acoustic signal for each time interval corresponding to the predetermined time interval.

### REFERENCE SIGNS LIST

10 karaoke apparatus
11 microphone
12 marking processing portion
12A client apparatus
12B server apparatus
13 audio effect application portion
14 adder
15 speaker
111 pitch feature amount analyzer
113 pitch detector
114 singing voice marking portion
121 song vocal cancellation processing portion
122 speaker
123 microphone
124 adder
125 echo estimating portion
131 pitch feature amount transmitter
132 pitch feature amount receiver
141 voice signal transmitter
142 voice signal receiver
143 marking information transmitter
144 marking information receiver
151 pitch feature amount transmitter
152 pitch feature amount receiver
153 marking information transmitter
154 marking information receiver
161 correct answer data delivery portion
162 pitch detector
163 singing voice marking portion
171 audio effect application determining portion
172 reverberation application portion
173 harmony application portion
174 addition portion
175 switch portion

1. An acoustic processing apparatus comprising:
a first feature amount calculator that calculates a first pitch feature amount from a music acoustic signal for each predetermined time interval;
a second feature amount calculator that calculates a second pitch feature amount from a target comparison acoustic signal for each time interval corresponding to the predetermined time interval; and
a similarity calculator that calculates a similarity between acoustic signals by comparison of the first pitch feature amount and the second pitch feature amount.

2. The acoustic processing apparatus according to claim 1,
wherein the target comparison acoustic signal is a singing voice signal.

3. The acoustic processing apparatus according to claim 2, further comprising:
an acoustic effect application portion that applies a predetermined acoustic effect to the singing voice signal according to the similarity.

4. The acoustic processing apparatus according to claim 1,
wherein the first feature amount calculator calculates signal intensity information for each time period or each frequency of the music acoustic signal as a first pitch feature amount, and
the second feature amount calculator calculates a time period or frequency of each signal component included in the target comparison acoustic signal as a second pitch feature amount.

5. The acoustic processing apparatus according to claim 4,
wherein the similarity calculator binarizes and uses the signal intensity information as the first pitch feature amount.

6. The acoustic processing apparatus according to claim 4,
wherein the similarity calculator uses, in addition to the time period or the frequency as the second pitch feature amount, a time period that is double the time period or a frequency that is ½ the frequency.

7. An acoustic processing method comprising the steps of:
calculating a first pitch feature amount from a music acoustic signal for each predetermined time interval;
calculating a second pitch feature amount from a target comparison acoustic signal for each time interval corresponding to the predetermined time interval; and
calculating a similarity between acoustic signals by comparison of the first pitch feature amount and the second pitch feature amount.

8. A program causing a computer to function as:
first feature amount calculating means for calculating a first pitch feature amount from a music acoustic signal for each predetermined time interval;
second feature amount calculating means for calculating a second pitch feature amount from a target comparison acoustic signal for each time interval corresponding to the predetermined time interval; and
similarity calculating means for calculating a similarity between acoustic signals by comparison of the first pitch feature amount and the second pitch feature amount.

9. An electronic apparatus comprising:
an accompaniment audio output portion that performs output of accompaniment audio according to a music acoustic signal;
an acoustic signal acquisition portion that acquires a target comparison acoustic signal; and
a signal processing portion that performs comparison processing between the target comparison acoustic signal and the music acoustic signal,
wherein the signal processing portion includes
a first feature amount calculator that calculates a first pitch feature amount from the music acoustic signal for each predetermined time interval,
a second feature amount calculator that calculates a second pitch feature amount from the target comparison acoustic signal for each time interval corresponding to the predetermined time interval, and
a similarity calculator that calculates a similarity between acoustic signals by comparison of the first pitch feature amount and the second pitch feature amount.

10. An acoustic processing apparatus comprising:
a marking processing portion that performs a marking processes based on a singing voice signal; and
an acoustic effect application portion that applies a predetermined acoustic effect to the singing voice signal according to a result of the marking process.

11. The acoustic processing apparatus according to claim 10,
wherein the marking processing portion performs the marking process by calculating a similarity between a music acoustic signal and the singing voice signal.

12. The acoustic processing apparatus according to claim 11,
wherein the marking processing portion includes a first feature amount calculator that calculates a first pitch feature amount from the music acoustic signal for each predetermined time interval,
a second feature amount calculator that calculates a second pitch feature amount for each time interval corresponding to the predetermined time interval, and
a similarity calculator that calculates a similarity between acoustic signals by comparison of the first pitch feature amount and the second pitch feature amount.

13. A server apparatus comprising:
a first feature amount calculator that calculates a first pitch feature amount from a music acoustic signal for each predetermined time interval; and
an information transmitter that transmits information based on the first pitch feature amount to a client apparatus.

14. The server apparatus according to claim 13, further comprising:
an acoustic signal receiver that receives a target comparison acoustic signal from the client apparatus;
a second feature amount calculator that calculates a second pitch feature amount from the target comparison acoustic signal for each time interval corresponding to the predetermined time interval; and
a similarity calculator that calculates a similarity between acoustic signals by comparison of the first pitch feature amount and the second pitch feature amount,
wherein the information transmitter transmits the similarity to the client apparatus.

15. The server apparatus according to claim 13, further comprising:
a feature amount receiver that receives a second pitch feature amount calculated from a target comparison acoustic signal for each time interval corresponding to the predetermined time interval from the client apparatus; and
a similarity calculator that calculates a similarity between acoustic signals by comparison of the first pitch feature amount and the second pitch feature amount,
wherein the information transmitter transmits the similarity to the client apparatus.

16. A client apparatus comprising:
an acoustic signal acquisition portion that acquires a target comparison acoustic signal; and
a similarity acquisition portion that acquires a similarity between acoustic signals calculated by comparison between a first pitch feature amount calculated from a music acoustic signal for each predetermined time interval and a second pitch feature amount calculated from the target comparison acoustic signal for each time interval corresponding to the predetermined time interval.

17. The client apparatus according to claim 16, further comprising:
a feature amount calculator that calculates the second pitch feature amount from the target comparison acoustic signal;
a feature amount receiver that receives the first pitch feature amount from a server apparatus; and
a similarity calculator that calculates a similarity between acoustic signals by comparison of the first pitch feature amount and the second pitch feature amount,
wherein the similarity acquisition portion acquires the similarity from the similarity calculator.

18. The client apparatus according to claim 16, further comprising:
a feature amount calculator that calculates the second pitch feature amount from the target comparison acoustic signal;
a feature amount transmitter that transmits the first pitch feature amount to a server apparatus; and
a similarity receiver that receives the similarity from the server apparatus,
wherein the similarity acquisition portion acquired the similarity from the similarity receiver.

19. An acoustic processing system comprising a server apparatus and a client apparatus,
wherein the server apparatus includes
a feature amount calculator that calculates a first pitch feature amount from a music acoustic signal for each predetermined time interval, and
an information transmitter that transmits information based on the first pitch feature amount to a client apparatus, and
the client apparatus includes
an acoustic signal acquisition portion that acquires a target comparison acoustic signal, and
a similarity acquisition portion that acquires a similarity between acoustic signals calculated by comparison between the first pitch feature amount and a second pitch feature amount calculated from the target comparison acoustic signal for each time interval corresponding to the predetermined time interval.
